(19) United States
(12) Patent Application Publication
(10) Pub. No.: US 2011/0137587 A1
(43) Pub. Date: Jun. 9, 2011

(54) SYSTEMS AND METHODS FOR MONITORING ROLLERS FOR CONVEYORS

(75) Inventors: Stephen M. Rothlisberger, Cambridge (CA); David G. Nelson, Milton (CA)

(73) Assignee: TCA Technologies Inc., Guelph (CA)

(21) Appl. No.: 12/797,047

(22) Filed: Jun. 9, 2010

Related U.S. Application Data
(60) Provisional application No. 61/185,442, filed on Jun. 9, 2009.

(51) Int. Cl. G06F 19/00; G06F 15/00; G01K 13/00; G01N 29/44; G01P 3/00

(52) U.S. Cl. 702/56; 702/184; 702/130; 702/145; 702/188

(57) ABSTRACT

The present invention at directed to systems and methods for monitoring a conveyor having a plurality of rollers spaced along the conveyer for supporting a conveyer belt. The system includes a plurality of roller monitors and a remote monitor. The roller monitors are located at the rollers, each of the roller monitors having sensors for measuring physical parameters of the rollers and generating measurement data indicative of the current values of the physical parameters, a roller processor connected to the sensors, the roller processor operable to receive the measurement data from the sensors, a roller data storage device connected to the roller processor operable to store the measurement data, a roller communication device connected to the roller processor operable to transmit the measurement data to a remote monitor. The remote monitor is operable to receive the measurement data to generate maintenance information for each of the rollers based on the measurement data.

### RELATED APPLICATIONS

This application claims priority from U.S. non-provisional patent application Ser. No. 61185442 entitled “System for Monitoring Bearings in Rollers for Conveyors” filed on Jun. 9, 2009, the entirety of which is hereby incorporated by reference.

### FIELD OF INVENTION

The present invention relates to monitoring systems, methods and apparatus and in particular monitoring systems, methods and apparatus for monitoring industrial equipment such as conveyors in industrial sites such as mines.

### BACKGROUND

In a mining operation, conveyors transport ore from the mine to the surface. A typical mine will have several miles of conveyors, supported by about 4,000 rollers per mile. Each roller has two bearings. These bearings usually fail in stages. First they become noisy. Then they heat up. That creates a fire risk where the heat may ignite grease on the rollers. In coal mines, coal dust creates a specific fire hazard. Finally the bearings will seize, or the bearing support structure will fail catastrophically. That may damage the conveyor belt and/or start a fire.

Mining operations mitigate these risks by continuously inspecting the conveyor manually. Mine workers continuously walk the length of the conveyors looking for overheated bearings. They listen for noisy bearings, they use a heat detection gun to take temperature readings, and they smell burning grease. None of these methods are accurate or precise.

By the time a hot bearing is detected, it is often no longer safe to operate. The worker therefore shuts down the conveyor to change the roller. Shutting down the conveyor stops the complete mining operation. This downtime is a direct loss of revenue. Such shutdowns are regular occurrences, and may happen several times a day on older conveyors.

Although it is impractical to completely prevent sudden bearing failures, it would be beneficial to predict a bearing failure in advance. That would allow the mine to shut down at a predictable, scheduled time, where multiple rollers on the verge of failure could be changed simultaneously. It would provide the mine operator with a significant positive financial impact through the reduction of downtime.

There is accordingly a need for a system that will continuously monitor the bearing health of each roller throughout the mine and predict bearing failures.

### SUMMARY OF THE INVENTION

According to one embodiment of the invention, there is provided a system for monitoring a conveyor having a plurality of rollers spaced along the conveyer for supporting a conveyer belt. The system comprises a plurality of roller monitors, each of the roller monitors being coupled to one of the rollers. Each of the roller monitors have at least one sensor for measuring a physical parameter of the roller and generating a measurement data indicative of a current value of the physical parameter, a roller processor connected to the at least one sensor, the processor operable to receive the measurement data from the at least one sensor, a roller data storage device connected to the roller processor operable to store the measurement data, and a roller communication device connected to the roller processor operable to transmit the measurement data. The system also has a remote monitor operable to receive the measurement data from the plurality of roller monitors and to generate maintenance information for each of the rollers based on the measurement data, the maintenance information being indicative of whether maintenance should be performed on one or more of the rollers.

The roller communication device in at least one of the roller monitors is operable to receive measurement data from at least one other roller monitor and retransmit that measurement data such that the roller monitor functions as a repeater node, and the roller monitors being configured to form an ad-hoc wireless network for communicating measurement data from the roller monitors to the remote monitor.

The at least one sensor in at least one of the plurality of roller monitors may include a temperature sensor, and the measurement data generated by that sensor includes a current temperature value of the bearing of one of the rollers, and the remote monitor is operable to determine when maintenance should be performed on that roller based upon the current temperature value.

The at least one sensor in at least one of the plurality of roller monitors may include a vibration sensor and the measurement data generated by that sensor includes a current vibration value indicative of an amount of vibration present in the bearings of one of the rollers, and the remote monitor is operable to determine when maintenance should be performed on that roller based upon the current vibration value.

The at least one sensor in at least one of the plurality of roller monitors may include a rotation sensor and the measurement data generated by that sensor includes a current rotational value indicative of rotational speed of one of the rollers, and the remote monitor is operable to determine that maintenance should be performed that roller based upon the current rotational value.

The system may further comprise a plurality of site monitors, each of the site monitors being located at a pre-selected site having a general environment. Each of the site monitors has a sensor for sensing an environment parameter related to the general environment of the site and is operable to transmit the environment parameter to the remote monitor via a network formed by the roller monitors and repeaters.

According to another embodiment of the invention, there is provided a roller monitor for a roller for use in supporting a conveyor belt. The roller monitor comprises at least one sensor mounted within the roller adjacent to a bearing of the roller for measuring a physical parameter of the bearing and for generating a measurement data indicative of a current value of the physical parameter, a roller processor connected to the at least one sensor, the roller processor operable to receive the measurement data from the at least one sensor, a roller data storage device connected to the roller processor operable to store the measurement data, and a roller communication device connected to the roller processor operable to transmit the measurement data to a remote monitor, the measurement data being usable to generate maintenance information indicative of whether maintenance should be performed on the roller.

According to another embodiment of the invention, there is provided a computer implemented method for monitoring a conveyer. The method comprises the steps of obtaining measurement data from at least one sensor coupled to a roller supporting a belt of the conveyer, the measurement data indicative of a current value of a physical parameter in the roller, storing the measurement data in a roller data storage device coupled to the roller, communicating the measurement data to a remote monitor using a communicating device, and generating maintenance information for each of the rollers based on the measurement data, the maintenance information indicative of whether maintenance should be performed on the roller.

### DRAWINGS

The embodiments herein will now be described, by way of example only, with reference to the following drawings, in which:

FIG. 1 is a simplified layout of an exemplary conveyor system where the system for monitoring a conveyor having a plurality of rollers spaced along the conveyer for supporting a conveyer belt may be installed;

FIG. 2 is a perspective view of an exemplary arrangement of rollers comprising roller monitors shown in FIG. 1 that support the conveyor belts;

FIG. 3 is an end view of a typical roller arrangement shown in FIG. 2, depicting relative roller size and location on both upper and lower belts;

FIG. 4 is a schematic diagram illustration a system 20 for monitoring a conveyer having a plurality of rollers for supporting a conveyer belt according to one embodiment of the invention;

FIG. 5 is a simplified cutaway sectional view of the interior of one of the rollers shown in FIG. 3, where the roller monitor shown in FIG. 4 is secured to a fixed shaft in a roller;

FIG. 6 is a simplified cutaway sectional view of an alternate layout for the interior of one of the rollers shown in FIG. 3, where the roller monitor 45 shown in FIG. 4 is secured to the rotating roller body of a roller;

FIG. 7 is a schematic representation of the coverage of various ad-hoc network formed by the rollers and network repeaters of the system of FIG. 1;

FIG. 8 is a schematic representation of a roller monitor shown of the system of FIG. 4;

FIG. 9 is a schematic representation of the network repeater shown in FIG. 4;

FIG. 10 is a perspective view of an exemplary portable handheld diagnostic tool carried by maintenance personnel to locate rollers shown in FIG. 2 that requires maintenance;

FIG. 11 is a schematic representation of the diagnostic tool shown in FIG. 10;

FIG. 12 is a schematic representation of the system shown in FIG. 4 with additional site monitors; and

FIG. 13 is a block diagram illustrating the steps of a computer method for monitoring a conveyer according to another embodiment of the invention.

### DETAILED DESCRIPTION OF THE INVENTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

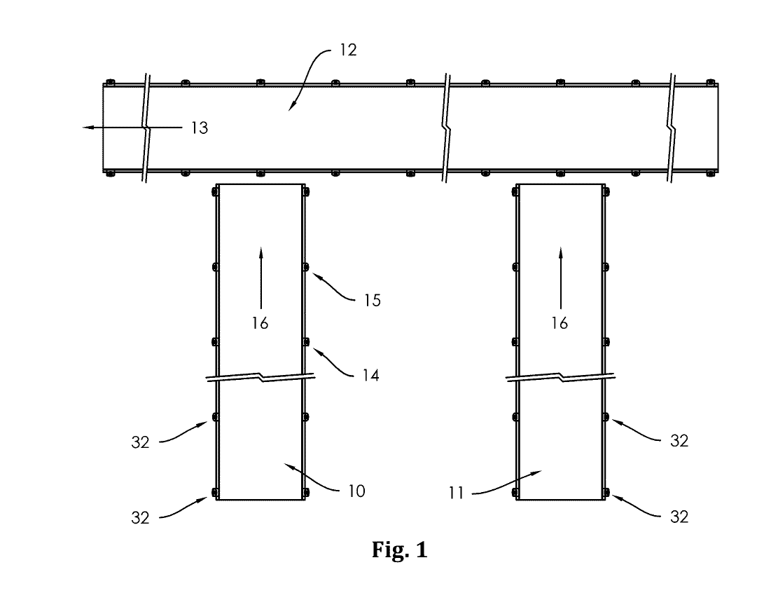

Typical mining operations remove ore from a mine face onto conveyors. Referring to FIG. 1, illustrated therein are three such conveyors 10, 11 and 12. Conveyors are typically assembled from modular units and often one conveyor 10 will be dismantled as mining progresses and the components used to assemble a new conveyor 11. Because of repeated assembling and dismantling, modular units initially assembled in one conveyor may become dispersed over a number of other conveyers. Assembling and dismantling conveyors is not a trivial process. Each conveyor may be two miles long and spaced 1,000 feet apart.

As mining operations remove ore from the mine face, a feeder conveyor 10 transports the ore to a main conveyor 12 in a direction indicated by 16.

The main conveyor 12 carries the ore to the surface in the direction indicated by 13. Note that FIG. 1 represents a single mine face. A typical mine will contain several active conveyors 10 and 11 feeding the main conveyor 12. Note also that typically these conveyors are not straight. They will curve to follow the contours of the ore seam underground.

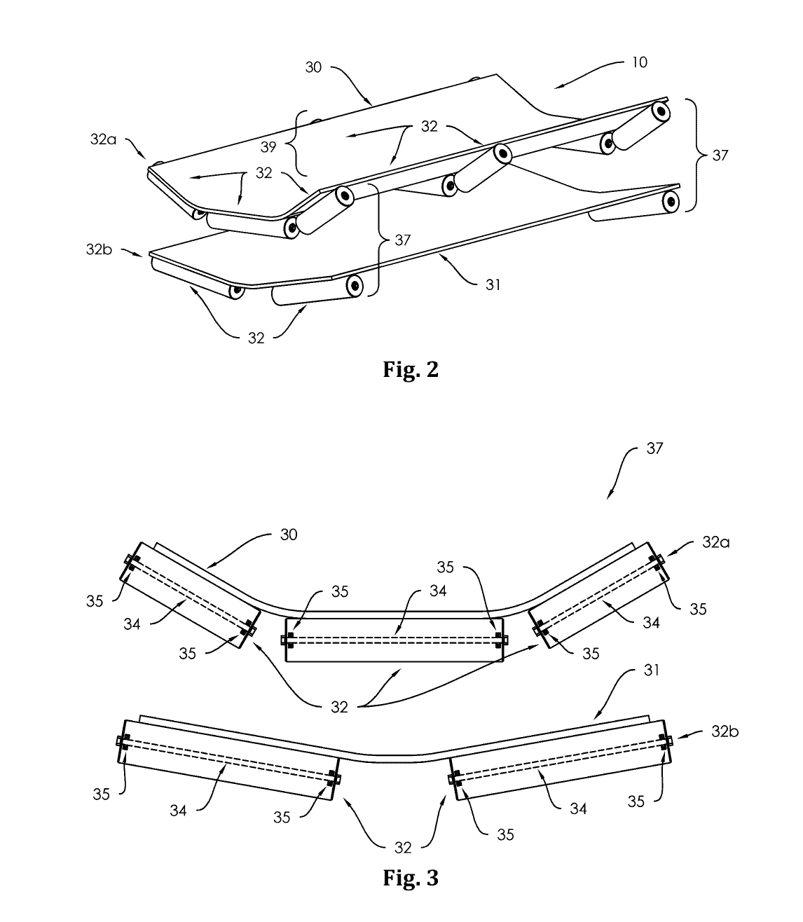

Referring to FIG. 2, the conveyors 10 and 11 each include conveyor belts 30, 31 supported by rollers 32. The rollers 32 on upper ore-carrying belt 30 may be spaced five feet apart, indicated in FIG. 1 by reference numerals 14 and 15. The rollers 32 on the lower return belt 31, which are directly beneath the rollers 32 on the ore-carrying belt 30, may be spaced ten feet apart. The roller monitor 45 is coupled to each of the rollers 32 to monitor the condition of the rollers 32 as described below.

The upper belt 30 is the feed conveyor, carrying ore out of the mine. The lower belt 31 is the return conveyor and travels empty (with no load). Rollers 32 support both belts. The feed conveyor 30 is loaded with ore and requires support rollers 32 in sets of three spaced five feet apart as generally indicated by reference numeral 32a. The return conveyor is not loaded at all and requires support rollers 32 in sets of two spaced ten feet as generally indicated by reference numeral 32b. Thus, rollers 32 are arranged in sets of five, as generally indicated by reference number 37, alternating with sets of three, as generally indicated by reference numeral 39. In this embodiment, there is a five-foot uniform spacing between sets.

Referring now to FIG. 3, illustrated therein is a frontal view of a five rollers 32 indicated generally as a set 37. The rollers 32 operate on a dead shaft system, where a shaft 34 through the center of each roller is fixed to a supporting frame (not shown). That is, the shaft 34 is stationary and does not rotate. Bearings 35 at each end of the roller support the roller 32 on the shaft 34 and allow the roller 32 to turn. The rollers 32 are idlers—they are not powered and do not propel the conveyor belt riding on them. Rather, the moving belt causes the rollers 32 to turn.

Eventually the bearings 35 on the rollers 32 fail. Dirt, dust, grit and water get into the bearings, increasing friction and damaging the contact surfaces inside the bearing. Rollers 32 may also experience excessive loads from twisting of the conveyor frame. Increased friction inside the bearings 35 or excessive loads on the rollers 32 causes the bearing temperatures to rise. The bearings 35 eventually get hot enough to ignite the grease in the bearing. A failed bearing 35 may also seize, locking the roller. The resulting friction between the moving conveyor belt 30, 31 and the stationary roller 35 causes a rapid temperature rise and damages the belt. This is particularly problematic in coal mines, where the increased temperature may ignite the coal dust in the air and the debris built up on the framework.

Once a bearing 35 fails, the roller 32 must be replaced. The conveyor 30 has to be stopped, the drives locked out, the belt lifted, the old roller removed, a new roller installed, the drives unlocked and the conveyor re-started. Heating of the failed roller 35, and possible subsequent fires, complicate this repair process. Although it is possible to shut down only one section of conveyor 30 to replace a roller 35, often the repair process will shut down the mine's entire conveyor system.

The present invention relates to a system for monitoring mine conveyors to prevent frequent unexpected downtime by predicting mechanical failure and scheduling appropriate maintenance. Data such as temperature and vibration will be gathered and used to predict roller bearing failure. A wireless mesh network is used to convey monitoring data and to notify personnel of appropriate timely maintenance procedures.

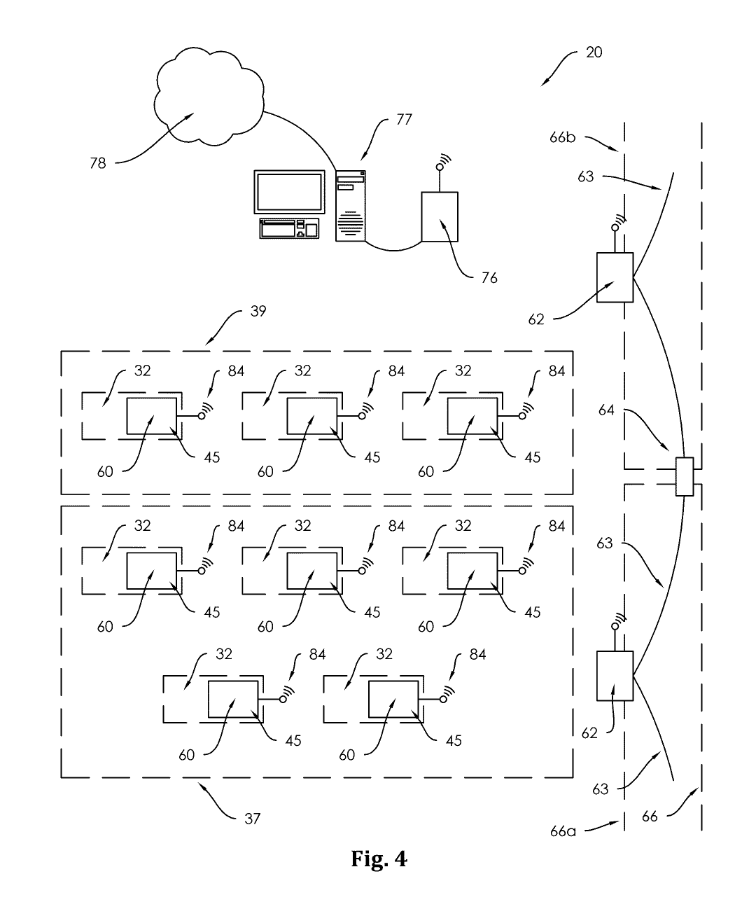

Referring to FIG. 4, illustrated therein is a system 20 for monitoring a conveyer having a plurality of rollers 32 for supporting a conveyer belt according to one embodiment of the invention. The system 20 comprises a plurality of roller monitors 45 coupled to each of the rollers 32. The roller monitors 45 are in data communication with each other and a plurality of network repeaters 62. The network repeaters 62 are in data communication with a remote monitor 77.

The roller monitors 45 and network repeaters 62 are configured to form an ad-hoc data network such as a mesh network such that components of the network may be removed or added without disrupting the data network. A wireless data transfer method was selected because mine conditions make cabling difficult to install, expensive to maintain and unreliable to operate.

A network formed by the roller monitors 45 and network repeaters 62 connects these monitored elements into a cohesive grid, providing a mechanism to transfer the monitored data to a remote monitor for analysis and reporting. This network is also used to disseminate maintenance reports to the appropriate personnel (e.g. the supervisor receives a list of rollers to replace at the next shutdown).

The system 20 made in accordance with the present invention monitors bearing temperature of the rollers 32 in the mine. Bearing temperature is the leading indicator of failure. Roller rotation and vibration are also monitored to detect jammed rollers 32. Monitored data is transmitted wirelessly along the length of the conveyor to the remote monitor 77 at the head of the conveyor, outside the mine.

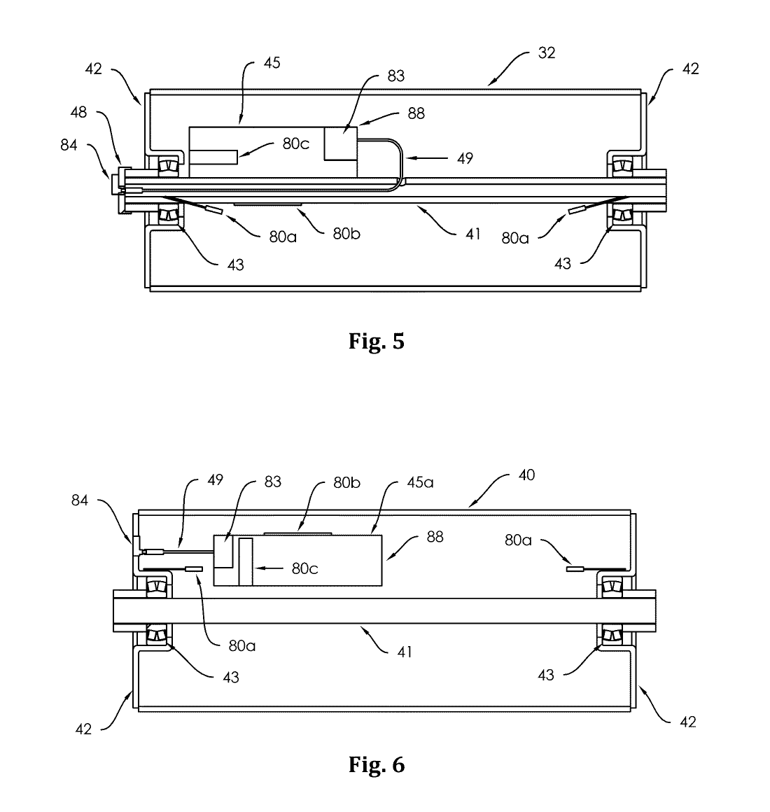

FIG. 5 illustrates a simplified cutaway sectional view of the interior of one of the rollers 32 having a roller monitor 45 secured thereto. The roller 32 comprises end caps 42 welded onto each end. Each end cap has a bearing 43 inset into the center of the end cap. The bearings support the roller on a fixed shaft 41. In this figure the shaft is shown to be hollow.

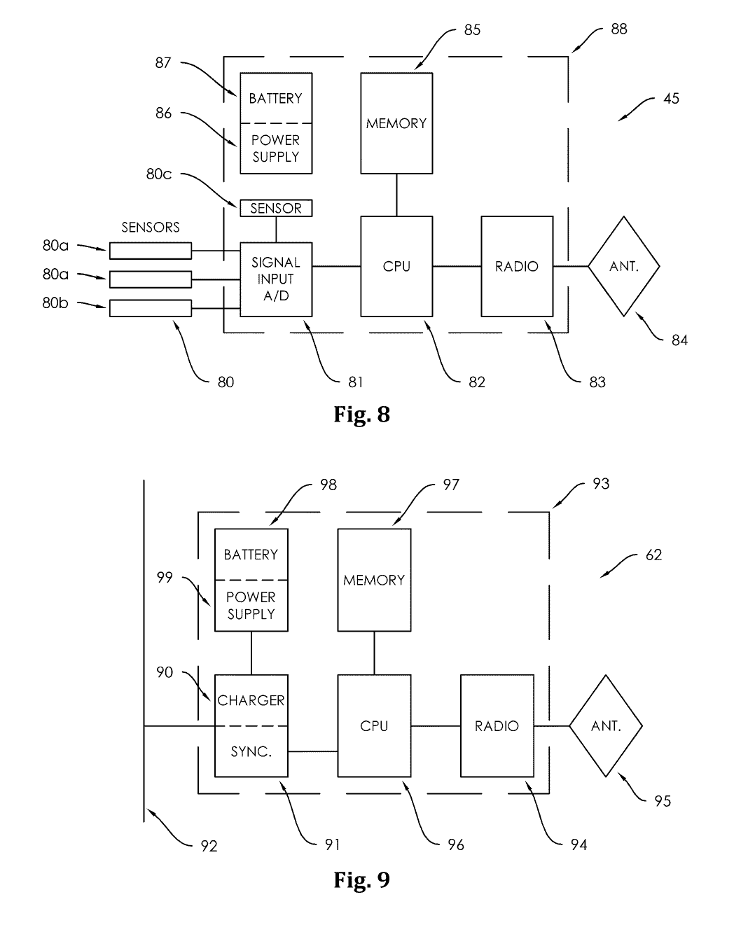

Referring to FIG. 8, illustrated therein is a schematic representation of the components of an exemplary roller monitor 45. The roller monitor 45 includes sensors 80 (e.g. two temperature sensors 80a, vibration sensor 80b, and a proximity sensor 80c), a signal input circuit 81, a roller processor 82, a roller communication device such as a radio transceiver 83, an antenna 84, and a roller data storage device 85. The roller monitor 45 is powered by a battery 87 connected to a power supply circuit 86. As shown, most of the components of the roller monitor 45 are enclosed in a roller monitor case 88. Only the sensors 80 and antenna 84 are external to the roller monitor case 88.

Referring back to FIG. 5, the roller monitor 45 in the roller monitor case 88 is clamped to the shaft 41. The temperature sensors 80a to measure the temperature of the bearings 43, and the vibration sensor 80b are attached to the shaft 41. Note that although the wires are not shown in the diagram, these sensors 44 are wired to the roller monitor 45. Within the roller monitor case 88 there is a proximity sensor 80c that measures the roller rotation. The radio transceiver 83 is connected to an external antenna 84 via a cable 49 running through the inside of the hollow shaft 41. The antenna 84 is embedded in the shaft end cap 48.

Referring now to FIG. 6, illustrated therein is the inside of a roller 40 incorporating the roller monitor 45a, made in accordance with an alternative embodiment of present invention. The roller 40 is similar to the roller 32 and like components between the rollers 40 and 32 are indicated by like reference numerals.

In this embodiment, the roller monitor 45a is coupled to the roller body and the antenna 84 is embedded in a recess in the roller end cap 42. Note that in this configuration the roller monitor 45, sensors 80, antenna 84 and cables all rotate continuously with the roller 40.

There is no external physical data connection from the roller monitor 45. All data is transferred wirelessly using the communication device. The communication device may be configured according to the IEEE 802.15.4-2006 and ZigBee standards to provide an ad-hoc network such as a mesh network. The mesh network provides multiple paths for transferring data, contributing to system robustness. For example, the communication device may be a 2.4 GHz transceiver module produced by RFM Inc.

Referring again to FIG. 8, each of the sensors 80 measures a physical parameter to generate measurement data indicative of a current value of the physical parameter. For example, the temperature sensors 80a measures the temperature of the bearings, the vibration sensor 80b measures the amount of vibration present in the bearings, and proximity sensor 80c measures the rotation of the roller 32.

The temperature, vibration and rotation sensors 80, are connected by wires to the signal input circuit 81. The signal input circuit 81 may contain amplifiers, signal conditioners and ADCs (analog to digital converters) to convert sensor readings into measurement data. That measurement data is read by the roller processor 82 and stored in roller data storage device 85. The roller processor 82 may aggregate the measurement data from the at least one sensor 80 in the roller data storage device 85 for a predetermined period of time prior to transmitting the measurement data to reduce network data traffic, to reduce power consumption by the communication device, or both.

At the predefined intervals, the roller processor 82 retrieves the measurement data from the roller data storage device 85 and transfers it to the radio transceiver 83. The radio transceiver 83 modulates a carrier wave with the measurement data and places the resulting signal on the antenna 84, where the measurement data is broadcast. The roller processor 82 interacts with the radio transceiver 83 to configure network communications, to receive commands from the network and to manage error correction.

The roller monitor 45 is powered by an internal battery 87 connected to a regulated power supply circuit 86. The battery 87 is selected to last the life of the roller 32 and may not be replaceable by the end user. In another embodiment, the roller monitor 45 may optionally be powered by a dynamo built into the roller 32, scavenging power from the roller's rotation.

Referring back to FIG. 4, illustrated therein is an exemplary local arrangement of the roller monitors 45. Each roller 32 contains one roller monitor 45, with an external radio antenna 84. Each roller monitor 45 and antenna 84 form a network node 60. The figure represents a ten-foot length of conveyor, consisting of a five roller cluster 37 followed by a three roller cluster 39. This pattern of eight rollers 32 may repeat every ten feet.

The network nodes 60 in the rollers 32 transmit their sensor data to a network repeater 62, embedded in the conveyor frame 66. Conveyors are assembled with ten-foot modular frames 66a, 66b onto which the rollers 32 are attached. The network repeater 62 aggregates the measurement data from nearby rollers 32 and transmits the measurement data wirelessly to the next network repeater 62 down the line. The network repeater 62 also receives measurement data from the previous upstream network repeater 62 and forwards it on. Thus, data is passed from repeater 62 to repeater 62 along the conveyor 30 until it reaches the remote monitor at the head of the conveyor 30 outside the mine.

The network repeaters 62 are continuously active and have greater power requirements than the roller monitors 45. Therefore, they are powered from a supply cable 63 running alongside the conveyor 30. The supply cable 63 is enclosed inside the conveyor frame for physical protection. Where frame sections 66a, 66b are joined there is an electrical coupling 64 to connect sections of the supply cable together. Note that this cable 63 only carries power. It does not carry data. All data is carried wirelessly. The supply cable 63 is not expected to be reliable, so each network repeater 62 will contain a rechargeable backup battery capable of sustaining the network repeater's operations for thirty days. Information on loss of power on the supply cable is relayed wirelessly to the monitoring and control center so that repairs may be performed. The backup battery continues to power the repeater until such repairs can be completed.

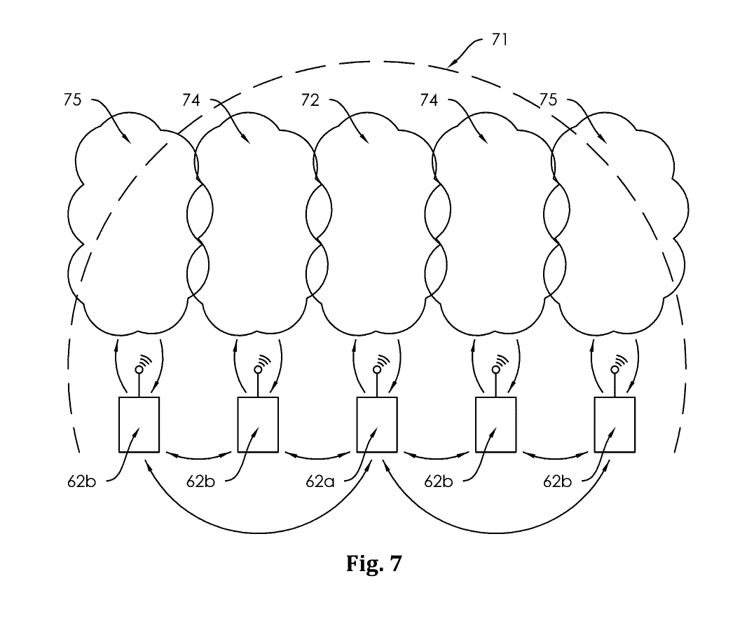

FIG. 7 shows a broader view of the operation of the network repeaters 62. In this figure, a given network repeater 62a interacts with the roller monitors in nearby rollers 32, the rollers 32 being represented by a cloud 72. The network repeater 62a also interacts with neighboring repeaters 62b. Note that although the network repeater 62 normally communicates only with its closest neighbors, its radio range 71 is wide enough to include several repeaters 62 along the conveyor. For simplicity the figure shows two upstream and two downstream repeaters 62b, but in practice each network repeater 62 could be in range of ten or more repeaters 62 in each direction. Network repeaters 62 may also be configured to support ad-hoc mesh networking architecture such that dismantling and reassembling of conveyor frame does not necessitate manual reconfiguration of the networking components.

The ability of the network repeaters 62 to communicate with repeaters beyond its immediate neighbors adds robustness to the system by providing redundancy. If one of the network repeaters 62 breaks down, responsibility for the monitoring data from the rollers 32 under that network repeater's control can be assumed by another repeater 62 close by.

In FIG. 7, network repeater 62a receives measurement data from its rollers 32 indicated by cloud 72 but may also receive measurement data from other rollers 32 indicated by clouds 74 and 75 if their corresponding network repeaters 62b stop working. Network repeater 62a may also skip over an adjacent non-working repeater 62b and transfer data to the next working repeater 62b.

FIG. 9 shows exemplary components of the network repeater 62. The network repeater 62 has a repeater processor 96, a communication device such as a network radio transceiver 94 and an antenna 95 connected to the repeater processor 96, a repeater data storage device 97.

The repeater processor 96 uses the radio transceiver 94 to receive measurement data from rollers 32 and from upstream repeaters 62. The measurement data is stored in local memory 97. The repeater processor 96 may aggregate the received measurement data in the repeater data storage device 97 for a predetermined period of time prior to transmitting the measurement data to reduce network data traffic, to reduce power consumption by the communication device, or both.

At the appropriate time, for example, at predefined intervals, the repeater processor 96 retrieves the data from the repeater data storage device 97 and transfers it to the radio transceiver 94 to transmit to the next downstream repeater 62. The repeater processor 96 interacts with the radio transceiver 94 to configure network communications, to negotiate its turn to transmit and receive, to receive commands from the network and to manage error correction. A rechargeable battery 98 connected to a regulated power supply circuit 99 powers the network repeater 62. The battery 98 and all electronics are enclosed in a case 93 enclosed within the conveyor frame. Only the antenna 95 is external to the case 93.

The network repeater 62 is also connected to a power supply cable 92 that runs through the conveyor frame. The power cable 92 supplies a charging circuit 90 that keeps the battery 98 charged. In the event of a power cable disruption the battery 98 will maintain the supply of power to the network repeater for a period of time (e.g. for thirty days).

The power cable 92 also carries a synchronization pulse. This pulse is injected into the cable periodically by the monitoring and control station. As the pulse travels down the cable 92 it is detected by the synchronization circuit 91, which notifies the repeater processor 96. Network repeaters 62 identify their physical position on the conveyor by timing the arrival of the synchronization pulse relative to neighboring network repeaters 62. The information about the physical location of the network repeaters 62 may then be used to obtain information about the physical location of failed rollers 32 or other rollers 32 of interest that are in data communication with each network repeater 62. This information is useful to the appropriate personnel to locate the rollers 32 that require maintenance. In other embodiments, physical location of network repeaters 62 may be identified by analyzing the data transmission pattern within the network.

Referring again to FIG. 4, the measurement data from the rollers 32 is passed along the conveyor 30 and ultimately handed over to a network controller 76 and stored on the remote monitor 77. This remote monitor 77 is operable to conduct high-level data analysis of the received measurement data. The remote monitor 77 calculates failure probabilities for the rollers in the system and generates maintenance reports for mine personnel. It notifies maintenance staff about roller health on a graduated scale: rollers that have failed, rollers that will soon fail, and rollers that are not expected to fail soon but that are nearing their end of life. Maintenance staff can then coordinate their operations to reduce unscheduled down time, replacing rollers in batches.

The remote monitor 77 is operable to determine when maintenance should be performed on one of the rollers 32 based upon the current temperature value. In one embodiment, the remote monitor 77 may be operational to determine that maintenance should be performed when the current temperature value for the bearings 43 exceeds a pre-selected temperature value. For example, if the normal run temperatures of the rollers 32 may be below 80° C., the remote monitor 77 may determine that one of the rollers 32 should be inspected during the scheduled maintenance if the current temperature value for that roller 32 is above 90° C. The remote monitor 77 may also determine that the one of the rollers roller 32 should be inspected on a more urgent basis (e.g. prior to scheduled maintenance) if the current temperature value for that roller 32 is above 100° C.

The remote monitor 77 may also monitor the rate of change of the temperature value for the rollers 32. The rate of change of the temperature value for a particular roller 32 may be calculated by determining the difference between the current temperature values obtained in two or more sets of measurement data from the same roller 32 and the difference in time when those measurement data were generated. The remoter monitor 77 may use the rate of change of the current temperature value to predict whether the temperature of the roller 32 is expected to exceed the pre-selected range within a pre-selected time period. For example, the rate of change may be used to predict whether temperature value of a particular roller 32 may exceed the pre-selected temperature values within the next 8-hour shift. If it is predicted that the temperature value of that roller 32 will exceed the pre-selected temperature values, the remote monitor 77 may determine that the particular roller 32 be flagged for maintenance even if the current temperature value is below the pre-selected temperature values.

The temperature values and timeframes provided above may vary in other embodiments of the system 20. Operator policies and practices as well as the manufacturer specifications for a conveyor and conditions of the operating environment may affect the selection of specific temperature and timeframe thresholds.

The remote monitor 77 is also operable to determine when maintenance should be performed on one of the rollers 32 based upon the current vibration value for the bearings 43 in that roller 32. In one embodiment, the remote monitor 77 may be operable to determine when maintenance should be performed if the current vibration value exceeds a pre-selected vibration value.

The remote monitor 77 may monitor the vibration value for that roller 32 over a period of time (e.g. several minutes) so that the vibration values obtained from that roller 32 are reflective of the vibrations caused within the roller 32 and not the surrounding environment. The vibration values may be compared to a local environment floor vibration value, which is an average of the vibration values for a number rollers 32 around the local area. The remote monitor 77 will determine the vibration value for a particular roller 32 relative to that floor value to determine whether the vibration value from that roller is caused internally within the roller 32 or by a phenomenon external to the rollers 32. For example, a passing mining truck may increase the vibration values of all of the rollers 32 along the path of the truck. However, this increase in vibration should not trigger false alarms as the vibration values measured in the rollers are a result of an external phenomenon. The remote monitor 77 may adjust the vibration value in the measurement data to account for the factors stated above to generate an adjusted vibration value, which more accurately reflects the vibrations, caused within a particular roller 32.

Generally, if the adjusted vibration value is below a pre-selected threshold (e.g. 0.3 g) there is no cause for concern. However, if the adjusted vibration value is above that threshold but below a second threshold (e.g. 1.5 g) a more detailed measurement may be made by the site monitor 45 to determine the fundamental frequency of the vibration. If the measured vibration frequency correlates to the roller rotation speed (as determined by the proximity sensor 80c), the remote monitor 77 may determine that the roller 32 be inspected at the next scheduled maintenance. Generally, a higher degree of correlation between the roller rotation speed and vibration value would suggest that the cause of the vibrations are the bearings 43 in the roller 32. As such, a roller with a higher degree of correlation may be prioritized for maintenance purposes. For example, a roller 32 with the above correlation factor value of 0.9 or above will be assigned the highest priority for inspection during the next scheduled maintenance. The vibration value of a roller 32 may also be cross-referenced to the temperature value for the same roller 32. The remote monitor 77 may prioritize a roller 32 that has increased vibration value and temperature value over other rollers 32 that has increased vibration value or temperature value, but not both values increasing simultaneously. If the adjusted vibration value for the roller 32 is above the second threshold (e.g. 1.5 g) the roller 32, the remote monitor 77 may determine that the roller 32 should be inspected on an urgent basis (e.g. prior to scheduled maintenance or immediately).

The remote monitor 77 is also operable to determine when maintenance should be performed on one of the rollers 32 based upon the rotational value obtained by the rotational sensor 80(c). A rotational value of zero indicates that the roller 32 is in a dead stop and the remote monitor 77 will determine that the particular roller 32 should be inspected on an urgent basis (e.g. prior to scheduled maintenance or immediately). Generally, rollers 32 in a local area will rotate at similar speeds and have similar rotational values. If the rotational value for a particular roller 32 is less than 80% of the average rotational value of rollers in the local area, then the remote monitor 77 may determine that the roller 32 be inspected at the next scheduled maintenance. In addition, the degree of slowdown (i.e. the difference between rotation value of the roller 32 in comparison to the area average) may be used to determine priority of inspection for that roller 32. The rotation speed may also be correlated to the vibration to determine priority as described above.

The remote monitor 77 archives the data to produce historical trends and comparisons. The remote monitor 77 may also be connected to the outside world via the Internet 78, allowing measurement data to be analyzed by the head office, by the conveyor manufacturers or by other stakeholders. Such external data access is encrypted and restricted for security purposes.

The remote monitor 77 may notify the staff of maintenance events through a screen at the remote monitor 77, through the Internet (via email, Instant Messenger, Twitter, Skype, etc.) and/or through a portable handheld diagnostic tool 100 carried by maintenance staff. The maintenance events may be provided in real time.

In the embodiment as shown, the remote monitor is a central monitoring station. However, in other embodiments, the remote monitor 77 may have a wireless communication device and sized and shaped to be portable such that a user may carry the remote monitor.

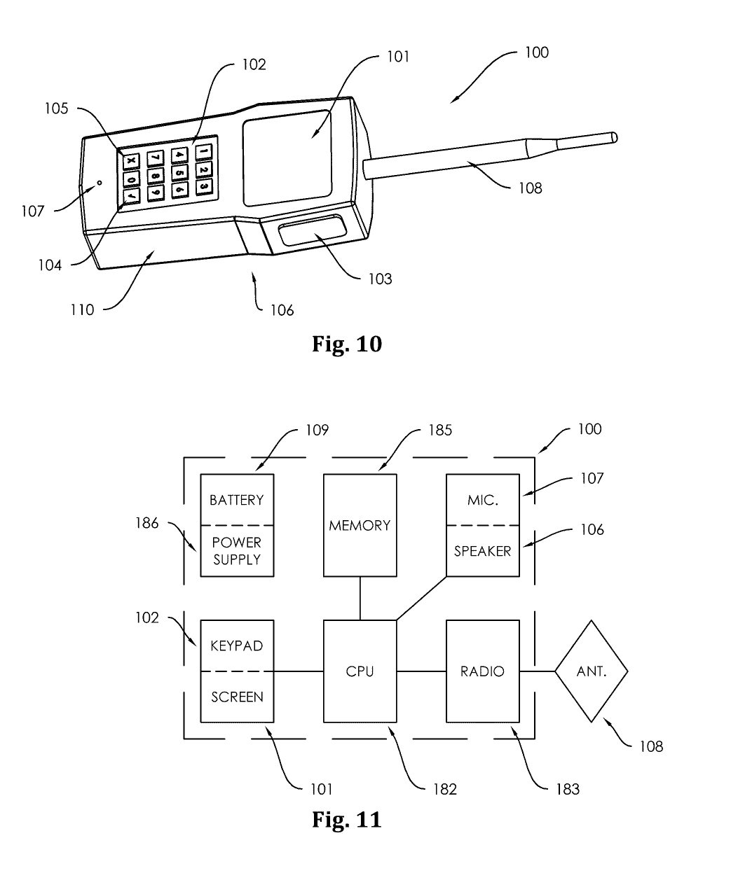

FIG. 10 illustrates an exemplary diagnostic tool 100. A ruggedized plastic case 110 contains the electronics and batteries to operate the diagnostic tool 100. Maintenance staff may clip the diagnostic tool 100 to their utility belt. A display screen 101 and keypad 102 allow the staff to interact with the remote monitor 77 at the monitoring and control station. The remote monitor 77 will inform staff of the location and nature of roller maintenance events. Information on the events will be displayed on the screen 101. Staff may use the keypad 102 to navigate a screen menu and to call up additional data they may require. Dedicated accept 104 and cancel 105 buttons on the keypad 102 allow simple and direct interaction with maintenance events. Note that FIG. 10 shows a functional representation of the diagnostic tool, and that actual units may differ in shape and layout.

The diagnostic tool 100 uses an antenna 108 to communicate over the same wireless radio network the roller monitors 45 in the rollers 32 and the network repeaters 62 operate on. Data to and from the diagnostic tool is carried by the network repeaters 62. Thus, the tool is only active if it is within the range of the rollers and/or network repeaters, which for example, may be within about a hundred feet of any conveyor.

The diagnostic tool 100 may also be used as an intercom, allowing staff along the conveyor to talk to each other. Voice signals are picked up by a microphone 107, converted to a digital representation and carried by the network to their intended recipient. The received digital representation of voice signal is decoded and played back over a loudspeaker 106. Staff uses a push-to-talk button 103 to alternate between talking and listening. Ordinary hand-held radios typically operate on line-of-sight, rendering them ineffective in a mine. The diagnostic tool takes advantage of the wireless network infrastructure to overcome this limitation.

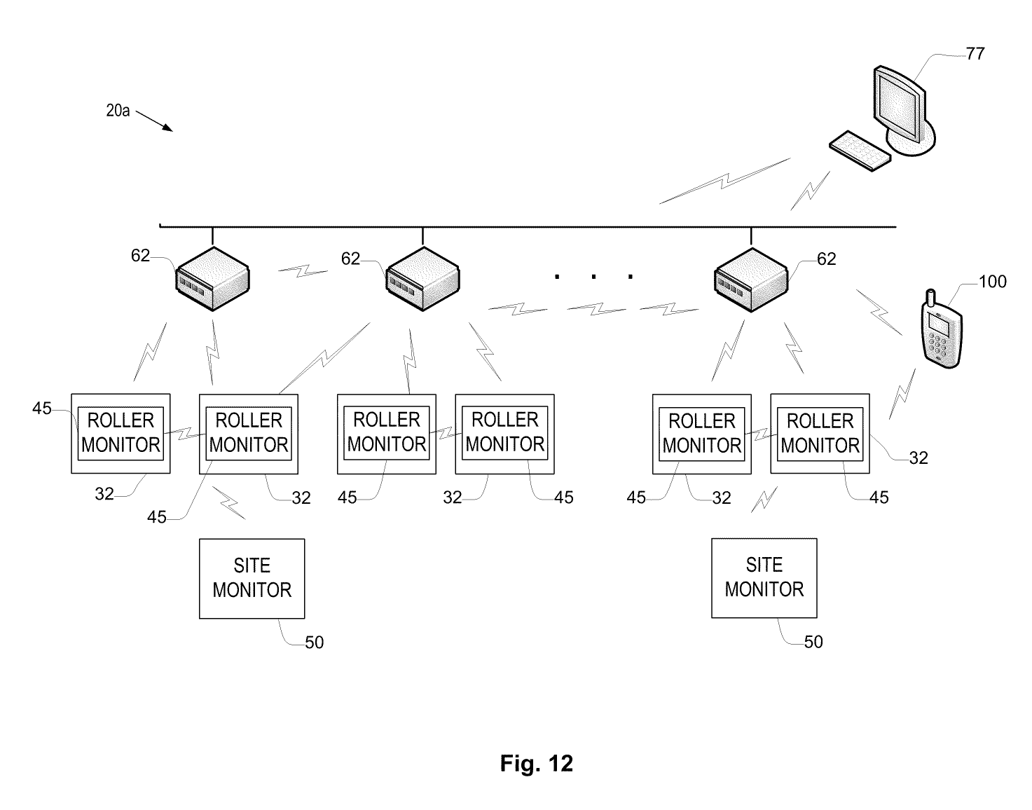

FIG. 11 shows the components of the diagnostic tool 100. The diagnostic tool processor 182 coordinates the operation of the device. It interacts with a radio transceiver 183 to configure network communications, to receive commands from the network, to receive maintenance events from the remote monitor 77, to send and receive voice signals to and from other diagnostic tools 100, to send commands and requests to the remote monitor 77 and to manage error correction. The radio 183 transmits and receives through an external antenna 108. The CPU 182 also formats data to display on the screen 101, scans the keypad 102 to detect key presses, converts voice signals on the microphone 107 to data, converts voice data to audible signals on the speaker 106 and monitors the battery level. Data used by the CPU 182 is stored in local memory 185. A rechargeable battery 109 and regulated power supply 186 power the unit. The battery, electronics and all other components are contained in a ruggedized plastic case.

The diagnostic tool 100 may be further operable to transmit signals to the remote monitor 77 at predetermined intervals using the existing network. The remote monitor 77 is further operable to receive the signals from the diagnostic tool 100 and generate location information based on network routing information of each received signal. The location information is indicative of the physical location of the portable diagnostic tool when the received signal was transmitted. By monitoring the location of the diagnostic tool, the remote monitor 77 may plot routes of various inspection personnel for safety auditing and management purposes.

The system 20 is shown installed in conveyers in a mine only for illustrative purpose. The invention may be used with conveyors located outside of mines which are used in other large-scale industrial operations.

The system of the present invention may also be adapted to monitor other factors in an industrial site. That is, the system may comprise site monitors that are in addition to the roller monitors 45 installed in the rollers 32. The site monitors may be located at various sites of interest for obtaining information about the sites. The various sites of interest may include industrial equipment other than rollers 32, or a more general location within the mine to measure environmental parameters around the site monitor.

Referring to FIG. 12, illustrated therein is the system 20a made in accordance with an alternative embodiment of the invention, having both the roller monitors 45 installed in rollers 32 and site monitors 50. Each of the site monitors 50 is in data communication with the remote monitor 77 through the network backbone formed by the roller monitors 45 and/or the network repeaters 62.

The components of the site monitors 50 are similar to those of the roller monitors 45. However, depending on the function of each site monitor 50, the type of sensors, size and shape of the casing or other characteristics of the site monitor 50 may be adapted to accommodate specific application of that particular site monitor 50.

If the system 20 is also being used to monitor the quality of air at an industrial compound, at least one of the sensors of the site monitor 50 may include an air quality sensor and the measurement data generated by that sensor includes information about air quality at the site.

Similarly, if the system 20 is being used to monitor a water level, for example at a pump, at least one of the sensors of the site monitor may include a water level sensor and the measurement data generated by that sensor includes information about water levels at the site.

Various measurement data generated by the site monitors 50 is transmitted back to the remote monitor 77 over the existing network for analysis. The addition of the site monitors 50 to the existing network backbone improve the versatility of the system 20.

The system of the present invention is believed to have a number of advantages, including scalability, robustness and traceability. These properties are implemented automatically, with no operator input required.

Scalability. The system operates equally well with a few devices (rollers) or with tens of thousands of devices. As operations progress the number of devices will fluctuate over time. In a mine, for example, ore seams are exhausted and the conveyors are dismantled and removed. Where new seams are begun the conveyors are reassembled and installed.

Robustness. The system tolerates and works around internal breakdowns. Failures in one device, or in a small group of devices, will not impede the operation of the system. That is, localized mechanical or electrical breakdowns will not affect the capabilities of the rest of the system.

Traceability. The system identifies elements of the monitored machinery that require maintenance. Location and routing information will be provided to the appropriate personnel, directing them to the physical location where maintenance is required. This is important in an environment where machinery is dismantled, moved, and reassembled every few months.

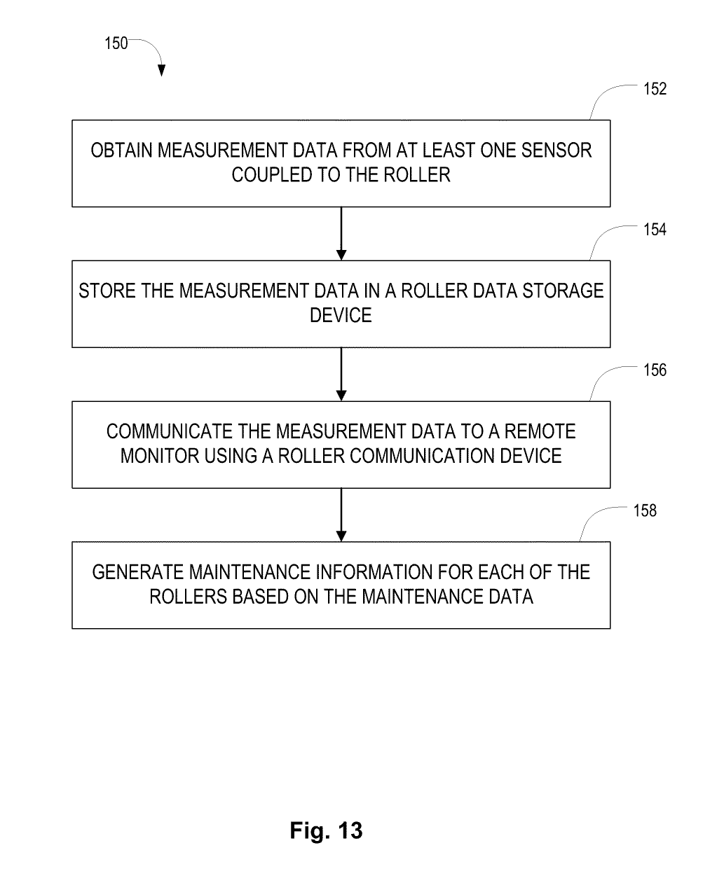

Referring to FIG. 13, illustrated therein is a computer implemented method 150 for monitoring a conveyer according to another embodiment of the invention. The method 150 begins at step 152.

At step 152, the method 150 obtains measurement data from at least one sensor coupled to a roller supporting a belt of the conveyer, the measurement data indicative of a current value of a physical parameter in the roller. The at least one sensor may be the same as the sensors 80 in the roller monitor 45 described herein above.

At step 154, the method 150 stores the measurement data in a roller data storage device coupled to the roller.

At step 156, the method 150 communicates the measurement data to a remote monitor using a communicating device. The communication device may be the same as the communication device for the roller monitor 45 described herein above.

At step 158, the method 150 generates maintenance information for each of the rollers based on the measurement data, the maintenance information indicative of whether maintenance should be performed on the roller.

While certain embodiments have been illustrated and described herein, many modifications, substitutions, and changes can be made to these embodiments without departing from the present invention, the scope of which is defined in the appended claims.

1. A system for monitoring a conveyor having a plurality of rollers spaced along the conveyer for supporting a conveyer belt comprising:
a) a plurality of roller monitors, each of the roller monitors being coupled to one of the rollers, each of the roller monitors having:
i) at least one sensor for measuring a physical parameter of the roller and generating a measurement data indicative of a current value of the physical parameter;
ii) a roller processor connected to the at least one sensor, the roller processor operable to receive the measurement data from the at least one sensor;
iii) a roller data storage device connected to the roller processor operable to store the measurement data; and
iv) a roller communication device connected to the roller processor operable to transmit the measurement data; and
b) a remote monitor operable to receive the measurement data from the plurality of roller monitors, and to generate maintenance information for each of the rollers based on the measurement data, the maintenance information being indicative of whether maintenance should be performed on one or more of the rollers.

2. The system according to claim 1, further comprising a plurality of network repeaters positioned and configured to relay measurement data from at least one of the plurality of rollers to the at least one monitor, each network repeater having a repeater communication device operable to receive and retransmit measurement data from at least one of the roller monitors to at least one of another network repeater and the remote monitor.

3. The system according to claim 2, wherein the remote monitor is further operable to determine the location of each of the network repeaters, and approximate the location of a particular roller by determining which of the plurality of the network repeaters that the particular roller is communicating with.

4. The system according to claim 3, wherein the plurality of the network repeaters are connected to a wired power source, and the remote monitor is further operable to cause a synchronization pulse injected into the wired power source, and identify the relative physical position of each repeater based upon a response from each repeater to the synchronization pulse.

5. The system according to claim 1, wherein each of the roller monitors is mounted within the roller adjacent to a bearing of the roller.

6. The system according to claim 1, wherein the at least one sensor in at least one of the roller monitors comprises a temperature sensor, and the measurement data generated by that sensor includes a current temperature value of the bearings of one of the rollers, and the remote monitor is operable to determine when maintenance should be performed on that roller based upon the current temperature value.

7. The system according to claim 1, wherein the at least one sensor in at least one of the plurality of roller monitors comprises a vibration sensor and the measurement data generated by that sensor includes a current vibration value indicative of an amount of vibration present in the bearings of one of the rollers, and the remote monitor is operable to determine that maintenance should be performed that roller based upon the current vibration value.

8. The system according to claim 1, wherein the at least one sensor in at least one of the plurality of roller monitors comprises a rotation sensor and the measurement data generated by that sensor includes a current rotational value indicative of rotational speed of one of the rollers, and the remote monitor is operable to determine that maintenance should be performed that roller based upon the current rotational value.

9. The system according to claim 1, wherein the roller communication device in at least one of the roller monitors is operable to receive measurement data from at least one other roller monitor and retransmit that measurement data such that the roller monitor functions as a repeater node, and the roller monitors being configured to form an ad-hoc wireless network for communicating measurement data from the roller monitors to the remote monitor.

10. The system according to claim 2, wherein the network repeaters are configured to form an ad-hoc wireless network for communicating measurement data from the plurality of roller monitors to the remote monitor.

11. The system according to claim 1, wherein the roller processor in at least one of the roller monitors is further operable to aggregate the measurement data from the at least one sensor in the roller data storage device for a predetermined period of time prior to transmitting the measurement data to reduce network data traffic.

12. The system according to claim 2, wherein at least one of the plurality of network repeaters further comprises a repeater processor connected a repeater data storage device and the repeater communication device, the repeater processor being operable to aggregate the received measurement data in the data storage device for a predetermined period time prior to retransmitting the received measurement data to reduce network data traffic.

13. The system according to claim 1, further comprising at least one portable diagnostic tool in wireless data communication with the remote monitor, the portable diagnostic tool being operable to receive the maintenance information from the remote monitor.

14. The system according to claim 13, wherein the portable diagnostic tool is further operable to transmit signals to the remote monitor at predetermined intervals, and the remote monitor is further operable to receive the signals from the portable diagnostic tool and generate location information based on network routing information of each received signal, the location information being indicative of the physical location of the portable diagnostic tool when the received signal was transmitted.

15. The system according to claim 1, wherein the remote monitor comprises a monitor communication device for receiving the measurement data from the plurality of roller monitors, a monitor processor connected to the communication device generating the maintenance information and at least one monitor data storage device connected to the monitor processor for storing the measurement data.

16. The system according to claim 1, wherein the remote monitor is a central monitoring station.

17. The system according to claim 1, wherein the remote monitor comprises a wireless communication device and the remote monitor is sized and shaped to be portable such that a user may carry the remote monitor.

18. The system according to claim 16, wherein the remote monitor is connected to a wide area communication network such that the measurement data stored in the monitor data storage device and maintenance information are accessible remotely.

19. The system according to claim 2, further comprising a plurality of site monitors, each of the site monitors being located at a pre-selected site having a general environment, each of the site monitors having a sensor for sensing an environment parameter related to the general environment of the site and being operable to transmit the environment parameter to the remote monitor via a network formed by the roller monitors and repeaters.

20. The monitoring system according to claim 19, wherein the at least one site monitor comprises a water level sensor, and the environment parameter comprises information regarding water levels at the site where that site monitor is placed.

21. The monitoring system according to claim 20, wherein the at least one site monitor comprises an air quality sensor, and the environment parameter comprises air quality information about the general environment where that site monitor is placed.

22. The monitoring system according to claim 1, wherein the roller comprises an elongate fixed shaft having a shaft end cap and a roller body rotatably coupled to the fixed shaft, and the roller monitor is secured to the fixed shaft and an antenna for the roller communication device is located in the shaft end cap.

23. The monitoring system according to claim 1, wherein the roller comprises a fixed shaft and a roller body having a roller end cap rotatably coupled to the fixed shaft, and the roller monitor is secured to the roller body and an antenna for the roller communication device is located in the roller end cap.

24. A roller monitor for a roller for use in supporting a conveyor belt comprising:
a) at least one sensor mounted within the roller adjacent to a bearing of the roller for measuring a physical parameter of the bearing and for generating a measurement data indicative of a current value of the physical parameter,
b) a roller processor connected to the at least one sensor, the roller processor operable to receive the measurement data from the at least one sensor,
c) a roller data storage device connected to the roller processor operable to store the measurement data, and
d) a roller communication device connected to the roller processor operable to transmit the measurement data to a remote monitor, the measurement data being usable to generate maintenance information indicative of whether maintenance should be performed on the roller.

25. A computer implemented method for monitoring a conveyer comprising the steps of:
a) obtaining measurement data from at least one sensor coupled to a roller supporting a belt of the conveyer, the measurement data indicative of a current value of a physical parameter in the roller,
b) storing the measurement data in a roller data storage device coupled to the roller;
c) communicating the measurement data to a remote monitor using a communicating device; and
d) generating maintenance information for each of the rollers based on the measurement data, the maintenance information indicative of whether maintenance should be performed on the roller.
